(19) United States
(12) Patent Application Publication
(10) Pub. No.: US 2009/0056396 A1
(43) Pub. Date: Mar. 5, 2009

(54) ANTI-THEFT PIN TUMBLER LOCK

(76) Inventor: Man Leung Thomas Liu, Kowloon (HK)

Correspondence Address: RABIN & Berdo, PC, 1101 14TH STREET, NW, SUITE 500, WASHINGTON, DC, 20005, US

(21) Appl. No.: 11/877,837

(22) Filed: Oct. 24, 2007

(30) Foreign Application Priority Data
Aug. 31, 2007 (CN) 200710145709.0

(51) Int. Cl. E05B 27/04

(52) U.S. Cl. 70/493

(57) ABSTRACT

An anti-theft pin tumbler lock includes a lock core and a lock body having a bore and at least one first bore. The lock core includes a keyway mounted therein, and one second bore formed therein and aligned with at least one first bore. One spring, one pin and one tumbler are sequentially received in the first and second bores and blocked using one plug. At least one second bore is configured in a stepped form, in which a diameter of one end is larger than that of another one, and the tumbler is configured in a corresponding form, in which the relative large diameter end thereof lies in the larger diameter second bore, while the relative small diameter end lies in the smaller diameter bore. An anti-bump space between the smaller diameter end and the end of the second bore adjacent to keyway is created.

### FIELD OF INVENTION

The present invention relates to a lock, especially to an anti-theft pin tumbler lock.

### BACKGROUND OF THE INVENTION

The pin tumbler locks are in the most common use nowadays, and are suitable for the internal and/or external doors of various architectures. Generally, the pin tumbler lock includes two main principal parts: the lock body and the lock core. Several radial bores are provided separately in the lock body and the lock core, in which a cylindrical pin and a snapped pin are received individually therein. An elastic element is also received in the bore of the lock body, so as to make the cylindrical pin close to the snapped one. In the locked state, the cylindrical pin is straddled at the interface between the lock body and the lock core. When a proper key is inserted into the key way on the outer end of the lock core, the snapped pin in the core bore will be pushed by the lands on the key and then will move to the cylindrical pin until it is exactly aligned at the interface. This allows the core to rotate, thus opening the lock. If the key is not inserted thereinto or the inserted key is improper, the spring-loaded cylindrical pin will be straddled at the interface, preventing the core from rotating. Thus, the lock is not able to be opened.

With the increasing use of the pin tumbler locks, its safety is more and more concerned. There is a way to open the pin tumbler lock without using the correct key: by means of a specially-made key (or called Bump Key), in which all the lands thereof are at the same height. When the special key is inserted into the keyway, all the snapped pins are still in the bore of the lock core. And the cylindrical and snapped pins touch each other, the cylindrical pins are straddled at the interface between the lock body and the lock core. When using a special bumping tool for hitting the outside of the key from one end of the core, the cylindrical pins are jumped away from the snapped pins, whereby forming a space between them instantaneously. If such a space covers the interface of the lock body and the lock core, one can open the pin tumbler lock before all the pins are pushed back by the springs in the lock.

As shown in FIG. 1, a prior art pin tumbler lock includes a lock body 20 having five longitudinal bores 24 and a lock core 60. Each cylindrical pins 30 having different sizes is received in a respective bore 24 of the lock body. A spring element 40 is mounted in the far end of each bore 24 in respect to the lock core. An opening 26 is formed on other end of the bore 24 adjacent to the lock core 60.

Typically, the lock core 60 is a central hollow cylinder, an external cylindrical surface of which is surrounded by the lock body 20. An arc-shaped interfaced space 50 is formed between the lock body 20 and lock core 60. A keyway 62 through which the key is inserted into the core is provided within the lock core 60. Five bores 24 butt-joined to and communicated with the bores 64 of the core are formed on the keyway 62. Each of snapped pins 70 having different height is located in each bore 64 of lock core 60. An opening 66 is formed on the outer surface of lock core 60, which is butt-joined to the opening 26, thus forming a pin receiving bore by the bore 24 being butt-joined to the bore 64. Under locked state, the cylindrical pins 30 are pushed downwards into the lock core by the springs 40, i.e. the pins 30 pass through the interface 50, whereby preventing the lock 10 from opening.

As shown in FIG. 2a, when a correct key 80 is inserted into the keyway 62 of the lock core 60, the snapped pins 70 and the cylindrical pins 30 in each of the lock core bores 64 will rise causing the springs 40 to be compressed. As the different depths corresponding to the snapped pins 70 having different heights lands of the key 80 have the boundary between the cylindrical pins 30 and the snapped pins 70 lies just on the intersecting space 50, so the key 80 allows the lock core 60 to rotate, thus opening the pin tumbler lock 10. As shown in FIG. 2b, the lock 10 is the opening state.

FIG. 3a shows the state of inserting the specified key 100 into keyway 62. As the lands 110 on the key 100 have same depths, when interested into the keyway 62, the snapped pins 70 are still located in the bore 64 of the lock core 60. At this time, the cylindrical pins 30 abut against the snapped pins 70. As shown in FIG. 3b, when the back of the key 100 is hit with a special bumping tool, the snapped pins 70 hit the cylindrical pins 30 and tend to move away from the pins 70. At that instant, a gap 55 exists between the cylindrical pin 30 and the snapped pin 70 .Before all the cylindrical pins 30 are pushed back by the springs, the special key 100 can be used to rotate the lock core 60 and to open the pin tumbler lock 10.

Obviously, the existence of the above mentioned bump key and the method for opening the pin tumbler lock using the same poses an extremely serious threat to the security and reliability of the pin tumbler locks.

Therefore, the persons skilled in the art are always devoted to developing an improved pin tumbler lock in order to prevent the pin tumbler locks from being opened by the bump keys and to achieve better security.

### SUMMARY OF THE INVENTION

For the above deficiency of the prior art, an object of the present invention is to provide an improved pin tumbler lock to prevent the lock of the prevent invention from being opened by the bump key and to achieve better security.

In order to achieve the above object, the present invention provides an anti-theft pin tumbler lock comprising: a lock body having a cylindrical bore formed therein and at least one first bore extending radially along the cylindrical bore; and a lock core matching the lock body and rotatably mounted in the lock body, wherein a keyway is longitudinally mounted therein and at least one second bore is radially formed therein and aligned with at least one first bore; wherein one spring, one pin and one tumbler are sequentially received in the first and second bores and then blocked by means of one plug; wherein at least one second bore is configured in a stepped form, in which a diameter of one end adjacent to the first bore is larger than that of another one, and the tumbler in the corresponding second bore is also configured in a corresponding stepped form, in which the relative larger diameter end thereof lies in the larger diameter second bores, while the relative smaller diameter end lies in the smaller diameter bore, and an anti-bump space between the smaller diameter end of the tumbler and the end of the second bore adjacent to the key way is created. Other snapped pins can reach the bottom of the bore of the lock core.

In the pin tumbler lock of the present invention, a bore of the lock core with same diameter in the pin tumbler lock of the prior art is changed to a step-shaped bore in which the upper bore diameter is bigger than that of the lower one, a corresponding snapped pin in the bore with same diameter is changed to a step-shaped pin in which the diameter of the upper portion is more than that of the lower portion, and the length of the smaller diameter end portion is configured less than that of corresponding bore, whereby forming an anti-bump gap between the smaller end of the step-shaped snapped pin and the end of the step-shaped bore (adjacent to the keyway).

Due to such a specially designed structure, the pin tumbler lock of the present invention may be opened by using a correct key. However, if a bump key is inserted into the keyway, when the bump key is hit, impulse energy is not able to be transferred to the step-shaped pin due to suck an anti-bump gap. As a result, the cylindrical pin is still in the original position, even when being hit, so that the lock core can not be rotated to keep the lock in a locked state.

The key technology of the present invention is to form a gap between the pushed-portion (smaller portion) of the snapped pin and the keyway. The anti-bump gap can prevent the impulsing force from being transferred to achieve the technical aim of preventing the lock from being opened by said bump key.

As a preferred embodiment, said step-shaped snapped pin is in an axisymmetric shape so as to allow the pin in the bore to have a better displacement performance.

As another preferred embodiment, two, many or all bores and the corresponding snapped pins can be configured in a step-shape to obtain better reliability.

Other objects, features and effects of the present invention will become apparent from the following description taken in conjunction with the accompanying drawings by way of conception, embodiments and technical effects of this invention.

### BRIEF DESCRIPTION OF THE DRAWINGS

FIG. 1 is a cut-away perspective view of a lock of the prior art;

FIG. 2a is a cut-away perspective view of the lock of FIG. 1, in which a correct key is inserted thereinto;

FIG. 2b is a cut-away perspective view of the lock of FIG. 2a, in which the lock is in an opened state;

FIG. 3a is a cut-away perspective view of the lock of FIG. 1, in which a bump key is inserted thereinto;

FIG. 3b is a cut-away perspective view of the lock of FIG. 3a, in which the bump key is hit so that the lock is opened;

FIG.4 is a cut-away perspective view of a lock of one embodiment of the present invention.

FIG. 5a is a cut-away perspective view of the lock shown in FIG. 4, in which a correct key is inserted thereinto;

FIG. 5b is a cut-away perspective view of the lock shown in FIG. 5a, in which the lock is in an opened state;

FIG. 6a is a cut-away perspective view of the lock shown in FIG. 4, in which a bump key is inserted thereinto; and

FIG. 6b is a cut-away perspective view of the lock shown in FIG. 6a, in which the bump key is hit.

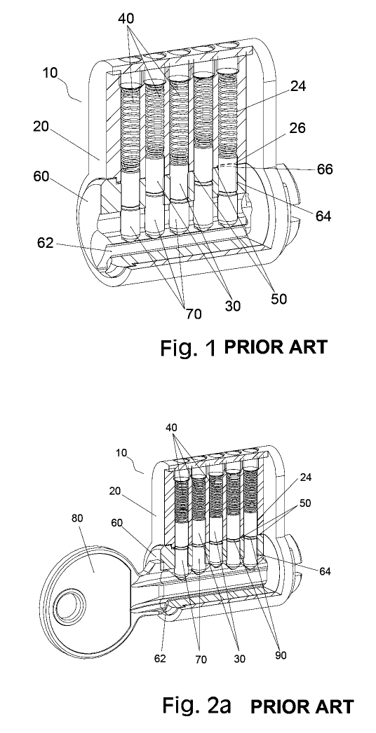

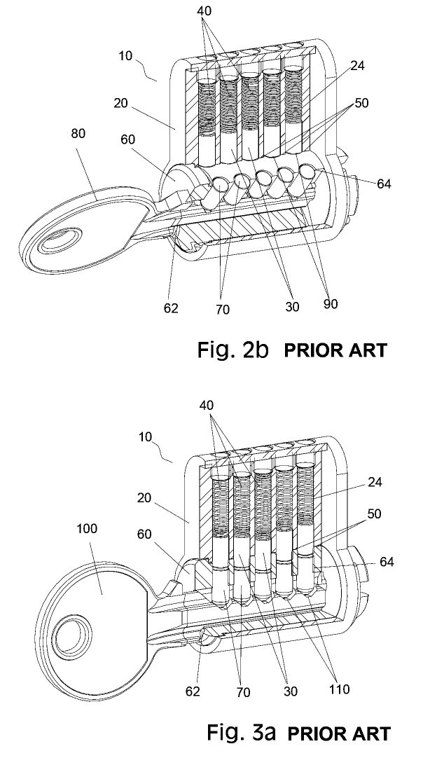

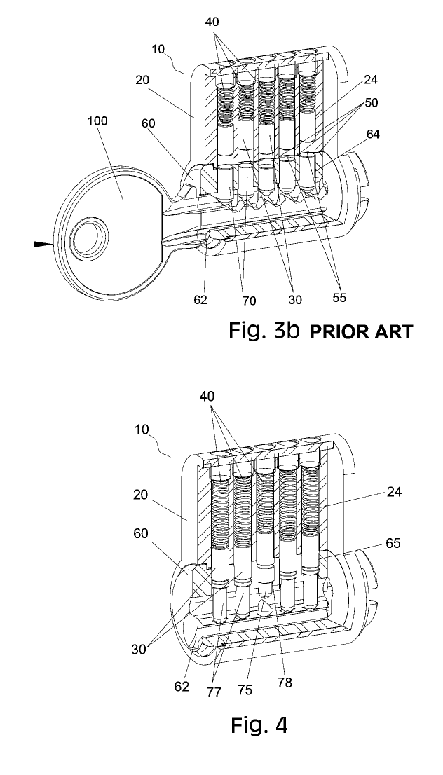

### DETAILED DESCRIPTION OF THE INVENTION

As shown in FIG. 4, in an embodiment of the invention, a lock 10 includes a lock body 20 having a cylindrical bore formed therein and five longitudinal first bores 24, and a lock core 60 matching the lock body 20 and rotatably mounted in the lock body 20, wherein a keyway 62 is longitudinally mounted therein, and five second bore 65 is radially formed therein and aligned with first bore 24; wherein one tumbler 77, one pin 30 and one spring 40 are sequentially received in the first and second bores and then blocked by means of one plug.

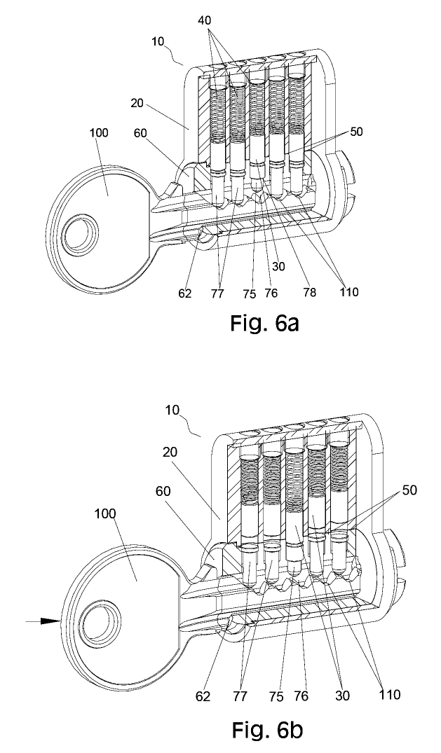

The special feature of the invention is that at least one bore 65 of the lock core is configured in a step-shape (for clarity, herein referred to along as 78) in which the diameter of the upper portion is bigger than that of the lower portion, while the snapped pin 77 in said bore 78 is correspondingly configured in a stepped shape (for clarity, herein referred to along as 75), in which the diameter of the upper portion is more than that of the lower portion, and the length of the step-shaped snapped pin 75 is configured less than that of corresponding second bore. Due to such a step-shape, the step-shaped snapped pin 75 is hanged in the stepped position of the bore to form a gap 76 (see FIG. 6a) between the end of smaller portion of the step-shaped snapped pin and the end of stepped bore 78 near keyway 62, while other snapped pins 77 can still reach the bottom of the bore 65 of the lock core.

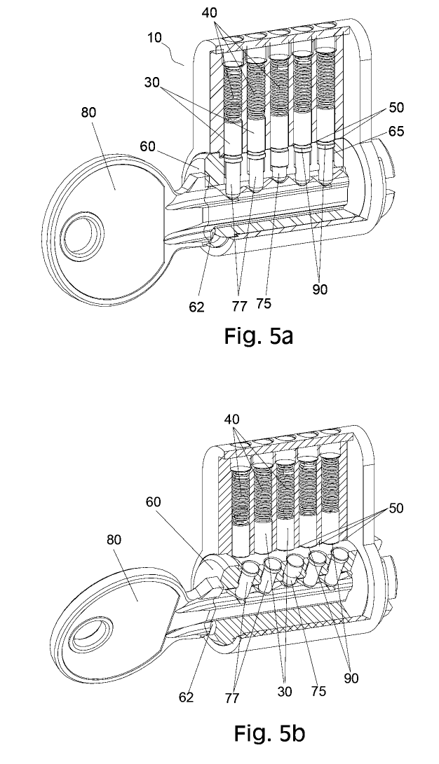

As shown in FIG. 5a, in the present embodiment, once a correct key 80 is interested into the keyway 62 of the lock core 60, the key 80 can push up each of the snapped pins 77 in the bores 65 of the lock core to each of the cylindrical pins 30, and then the snapped pins 77 again push the cylindrical pins 30 to the springs 40 with torque applied to the lock core. As the different depths of the lands on the key match the lengths of the corresponding snapped pins 77 (including step-shaped snapped pin 75), the contacting surface of each cylindrical pin 30 and snapped pin 77 (including step-shaped snapped pin 75) is just in the intersected space 50. Under this circumstance, the lock core 60 is rotated by the key 80 and the lock 10 is opened. As shown in FIG. 5b, the lock 10 is in an opened state.

As shown in FIG. 6a, in the present embodiment, when a bump key 100 is inserted into the keyway 62 of the lock core 60, smaller end of step-shaped snapped pin 75 in the bore 78 of the lock core is not connected with lands 110 of said key 100 because of all lands 100 having the same height and anti-bump gap 76. When the key 100 is hit using tools, four snapped pins 77 contacted with the lands 110 of said key 100 will be attacked and impulse force is transferred to cylindrical pins 30 so that the cylindrical pins tend to move away from the snapped pins. As a result, an instant separation between the four snapped pins 77 and the cylindrical pins 30 occurs. As shown in FIG. 6b, because the gap 76 occurs, the step-shaped snapped pin 75 is not contacted with the lands 110 of said key 100 and not attacked. Therefore, the corresponding cylindrical pin 30 is still in place, i.e. the pin 30 thus preventing the lock from turning.

In another embodiments of the invention, the snapped pins are not limited to cylinder only, and also include other axisymmetric shape such as cube, hexahedral body or the like, so long as they in the bore have a balanced friction to obtain good performance of displacement and keep good contact with the lands of the key.

In another embodiments of the invention, if having a number of the bores and corresponding amount of the snapped pins, two many or all the bores and the snapped pins may be designed to be in a stepped shape to obtain better reliability.

In the present embodiment, the springs may also be replaced by some other elastic elements.

The implementations and the contents disclosed in the description can be reference only and this lock structure can also be used in other kind of locks.

Although only the above mentioned implementations are disclosed in the foregoing description, it will be understood that those skilled in the art may make various modifications without departing from the spirit and the scope of this invention. Accordingly, other implementations are within the scope of the claims claimed in this invention.

1. An anti-theft pin tumbler lock, comprising:
a lock body having a cylindrical bore formed therein and having a plurality of bores extending radially along the cylindrical bore;
a lock core matching the lock body and being rotatably mounted in the cylindrical bore of the lock body, the lock core having a keyway longitudinally disposed therein, and having a plurality of second bores radially formed therein and aligned with respective ones of the first bores, at least one of the second bores being configured to have a stepped form, said at least one second bore having one large diameter end adjacent to a respective first bore which end has a diameter that is larger than an opposite, small diameter end of the second bore, and
a spring, a pin and a tumbler sequentially received in the corresponding first and second bores, the tumbler received in the corresponding at least one second bore that has a stepped form also being configured to have a corresponding stepped form, the tumbler having the stepped form having one end that has a large diameter which is disposed in the large diameter end of the second bore, and having an opposite end having a small diameter which is disposed in the small diameter end of the second bore, with an anti-bump space being formed between the small diameter end of the tumbler and the small diameter end of the second bore, and the tumblers received in the remaining second bores each having a respective end that reaches a bottom of the respective second bore, so that no anti-bump space is formed therebetween.

2. The anti-theft pin tumbler lock as claimed in claim 1, wherein the stepped tumbler has an axisymmetric shape.

3. The anti-theft pin tumbler lock as claimed in claim 1, wherein the small diameter end of the tumbler has a length that is less than a length of the small diameter end of the corresponding second bore.
